(19) United States
(12) Patent Application Publication
(10) Pub. No.: US 2010/0155176 A1
(43) Pub. Date: Jun. 24, 2010

(54) LADDER SAFETY SEAT

(75) Inventors: RICHARD T. LOHR, Youngstown, NY (US); Carl Fila, Williamsville, NY (US); Jason Suitor, Youngstown, NY (US)

Correspondence Address: Law Offices of James J. Ralabate, 5792 Main St., Williamsville, NY, 14221, US

(73) Assignee: INTERNATIONAL CHIMNEY CORPORATION, WILLIAMSVILLE, NY (US)

(21) Appl. No.: 12/341,213

(22) Filed: Dec. 22, 2008

(51) Int. Cl. E06C 7/16

(52) U.S. Cl. 182/113; 182/116

(57) ABSTRACT

This is a safety rest seat for permanent attachment to a lengthy ladder. A plurality of these safety seats is installed at different intervals on the ladder to provide resting areas for the climber, as needed, as he or she climbs upward or downward. The seat in an active seating position rests upon horizontal, permanently secured seat supports. Once the climber lifts out of his or her seated position on the seat, the safety seat portion will automatically rotate upwardly into an inactive, out of the way position so that it does not obstruct the climbing path. A counterweight is located at a rear section of the seat which automatically causes the seat to rotate upwardly to an inactive position when no downward pressure (or a seated user) is no longer exerted upon the seat.

This invention relates to permanent long ladders and, more specifically to a safety/rest seat for attachment to said ladders.

### BACKGROUND

There are known various devices installed on ladders for various usages that may enhance the convenience of the climber. Many of these ladder attachments or devices include platforms or seats that are removable or foldable or swingable from the main ladder rungs or side rails. These devices can serve a specific practical purpose, usually to assist in a work task. Unfortunately, these devices do not function as a safety/rest seat. Maintenance on or construction of structures including work on shorter structures such as telephone lines, cable television or utility poles or lamp posts present one set of problems. Work on much taller structures such as chimneys present completely different and more serious problems because of the heights involved and the potential dangers inherent in climbing these substantially taller structures. The need for safety and resting is an important issue on taller structures.

Given the shortcomings in the prior art, it is desirable that safety devices include means to securely ascend and descend the ladder assembly, as well as have easy and convenient access to a seat, platform or rest assembly, if desired. It would be advantageous and an improvement if the seat assembly attached to the ladder be pivotable and have supports to place it in a position for use, and in a position of non-use (inactive). It would be desirable for the seat assembly supports to have an opening to allow the climber to pass through the inactive seat assembly while ascending the ladder. Such devices additionally would ideally have a plurality of these seats permanently installed at intervals so as to be available to rest at different heights relative to the ground. To further enhance security, the ladder assembly should include a safety harness system to permit the user to be connected at all times even when using the present safety seat of this invention. This system which includes the present safety/rest seat and harness to be worn by the user will permit normal movement ascending and descending the ladder assembly with total safety and rest option. The present invention addresses several shortcomings in prior art devices which were developed to be used for work tasks at elevated levels above the ground surface.

An important consideration for ladders used on these tall structures such as industrial chimneys is to provide these safe rest stops or seats for climbers of these permanent ladders on industrial chimneys which have a fall prevention rail-type system. Rest stops of this invention are used by climbers only if the climber wants to rest, otherwise the climber can by-pass the rest safety seats. Ladders on chimneys are traditionally one continuous run of ladder having no offsets where one would side-step onto another adjacent ladder. Chimney ladders do not require offsets but long ladders on non-chimneys do. Rest stops on chimney ladders are not required by OSHA but many customers knowing the importance of these rest stops now want and require them.

There are many prior art patents which address the use of rest stops in ladders, both short and tall. Some of these prior art patents or publications are Leeland Des. 322,485; Wollin U.S. Pat. No. 4,339,024; Petitjean FR 2487423; Moberg U.S. Pat. No. 2,151,135, Breedlove Pub. No. U.S. 2007/0256892A1 and Creecy et al U.S. Pat. No. 279,347. None of these patents or publications discloses a substantially tall ladder with a plurality of permanent, attached safety seats or platforms that automatically swing back to an inactive position when the climber lifts off the seat and continues the ascent up the ladder.

### SUMMARY

The present invention provides a ladder safety resting seat where intermediate levels of these seats are installed onto the ladder. Climbers wanting to rest can easily do so by stopping, grabbing, rotating and sitting on the seat platform of this invention. He need not disconnect the harness from the climb rail slide. The climber can be sitting on the seat and still remain attached to the fall protection device to satisfy OSHA's safety requirements. The present invention provides safe rest stops or safety seats for climbers of permanent, straight run, ladders on industrial chimneys or the like which have a fall prevention rail-type system or a ladder cage. These rest stops or seats are used by climbers only if the climber wants to rest; otherwise the seats remain in an upward inactive position. Ladders on chimneys in the prior art are traditionally one continuous run of ladder having no offsets where one would side-step onto another adjacent ladder. Chimney ladders do not require offsets, but long ladders on non-chimneys do require offsets every 20′-30′, as above noted. While the present embodiments will describe the invention as it relates to use on a tall chimney structure, it is understood that the safety seat of this invention can be used with any structure besides a chimney with equal effectiveness.

The safety seat assembly easily and permanently attaches to a new or existing ladder and when not in use is fully out of the way of the climbing path. When a climber wants to rest, he grabs the top of the counterweighted seat behind him, rotates it down to a horizontal active position and sits down. A key feature to this is that the climber need not detach his harness from the climb rail slide and need not have a lanyard. This satisfies OSHA tie-off requirements. The frame and bracket opening of the present invention does of course satisfy OSHA clearances.

The safety seat of this invention provides the following advantages:
It totally replaces the need for rest platforms saving substantial fabrication and field labor costs.
The climber could sit to rest as desired.
Some “tight” situations could utilize a safety seat but may not have enough room for a rest platform.
It is a simple and easy solution to prior art needs.
It highly simplifies the climber's resting and safety objective.
It has a counterweight on its back portion of the seat overhang which causes the seat to automatically swing up when the seat is not in use.
It has a leg space for a sifting user when the seat is in the operable active position.

The safety seat of this invention comprises horizontal and diagonal support members that are securely attached to the side rails of the ladder by welding, bolting or other secure attachment means. The seat portion is pivotally connected to the back portion of the horizontal member. The seat portion is pivotally connected at its rear portion so that it can rotate upwardly to an inactive position when not in use. The seat portion has an overhang that extends beyond the two seat supports. Important to an embodiment of this invention is that this overhang be counterweighted so that it will automatically swing up to an inactive position when not in use. At the front seat portion, the seat leaves leg space for a user by stopping the seat substantially short of the front end of the seat supports. In one embodiment, when the seat rotates upwardly to the inactive position out of use, the weighted overhang will force the seat substantially vertical and slightly beyond vertical to ensure the inactive seat is clear of the climbing path. Rising above the seat portion in one embodiment are arm and back guard rails that provide further safety security to the user and prevent any side or back sliding of the user off the seat portion. The opening between the inactive seat and the ladder leaves enough room for a climber to climb beyond an unused safety seat.

### BRIEF DESCRIPTION OF THE DRAWINGS

FIG. 1 is a perspective view of one ladder embodiment of this invention as the ladder extends upwardly on a chimney for use by a climber to reach the top and lower portions of the chimney.

FIG. 2 is a side perspective view of an embodiment of the safety seat of this invention when the seat is folded down in a usable position.

FIG. 3 is a side perspective view of an embodiment of the safety seat where the seat portion is pivoted upwardly when not in use.

FIG. 4 is a side perspective view of an embodiment of this invention which shows the safety seat in use where the ladder climber is resting thereon.

FIG. 5 illustrates a climber seated on the safety seat of this invention.

FIG. 6 shows the climber out of the safety seat and proceeding to ascend up the ladder.

FIG. 7 shows the position of the counterweight of this invention below the seat overhang.

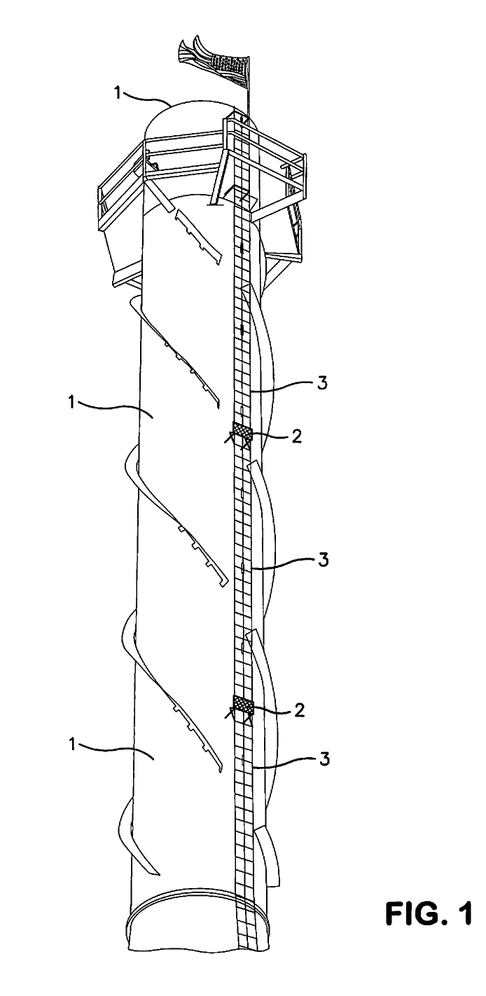

In all of the above FIGS. 24, the ladder length is shown stopping at the safety seat; this is only for clarity. In actual use, the ladder continues upwardly beyond the seat to other seats at any ladder length such as a length shown in FIG. 1.

### DETAILED DISCUSSION OF DRAWINGS AND PREFERRED EMBODIMENTS

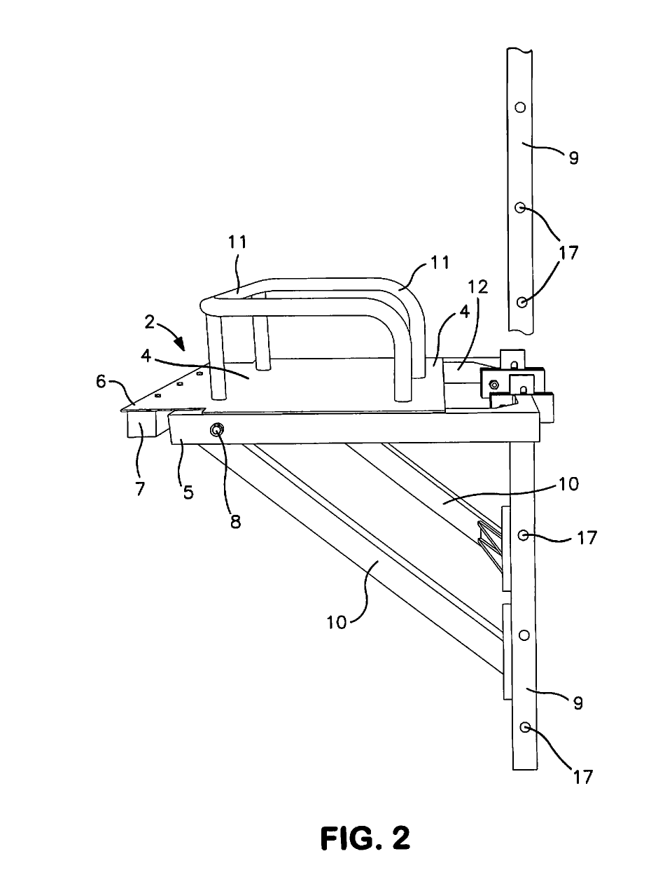

In FIG. 1, a tall structure such as a chimney 1 is shown as an example of where on the ladder 3 the safety seat of this invention can be used. As earlier indicated, reference to the invention as it relates to chimneys is by way of illustration and not limitation. The safety seats 2 of this invention can be used on or with any ladder on any structure of any desirable length such as TV towers, water towers, bridges, aviation lighting structures or towers and the like. In FIG. 1, a tall chimney 1 is shown with a plurality of the safety seat 2 of this invention (any suitable number of seats may be used) installed at various levels and secured to ladder 3. The specifics of safety seats 2 are for clarity not shown in FIG. 1. The details of embodiments of the safety seat 2 of this invention are shown in FIGS. 2-7. FIG. 1 is merely presented to illustrate how a plurality of safety seats 2 are located and used on ladders 3 in tall structure such as a chimney 1.

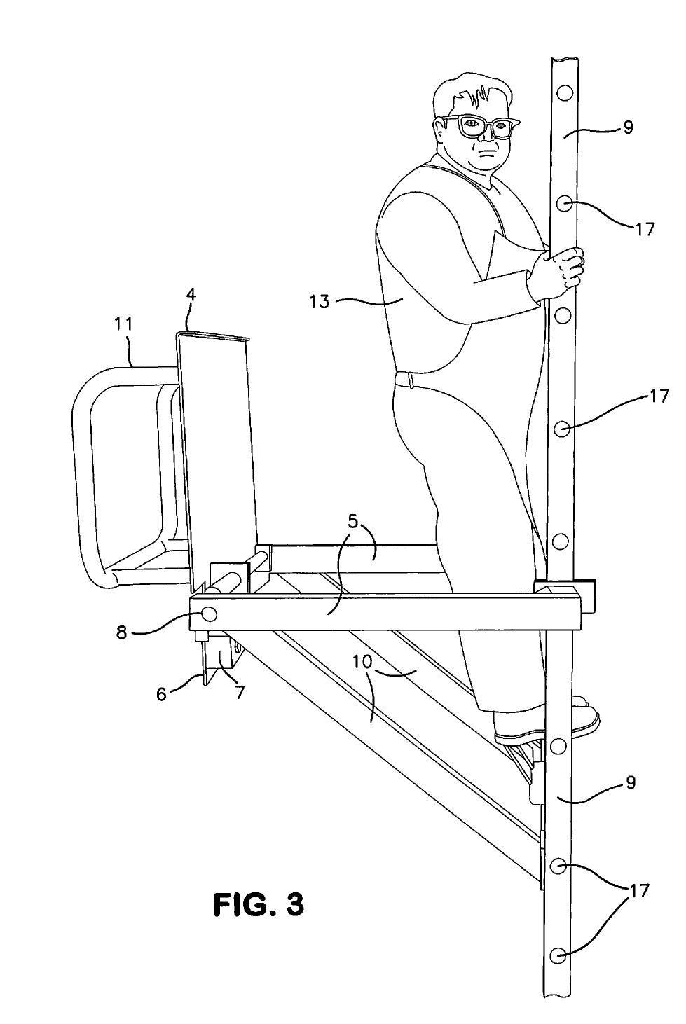

In FIG. 2, an embodiment of the safety seat 2 is shown in an active or operable position where the seat section 4 is down ready for a climber to sit thereon. The seat section 4 at its rear portion 6 extends beyond the horizontal seat support 5 as shown by seat rear overhang or extension 6. As earlier noted, in one embodiment, it is important that rear seat extension 6 have a counterweight attachment 7 so that when seat 2 is not in use, the weight of the counterweighted rear seat extension 6 will automatically cause the seat structure 2 to rotate upwardly to the position shown in FIG. 3. Seat section 4 is pivotally mounted on a hinge 8 so that seat section 4 can automatically swing or pivot upwardly when a user is not seated thereon. In FIG. 2, the seat section 4 is shown resting on horizontal seat supports 5 but in reality, when no one is seated on the seat section 4, it will automatically rotate or pivot upwardly as shown in FIG. 3. The horizontal seat support 5 is connected to the diagonal support 10 at their intersection near hinge 8. Each of these support members has a short extension perpendicular to the ladder side rail 9. At the end of each short extension is an attachment plate. These plates will be secured or bolted to the ladder side rail 9. The assembly of these horizontal and diagonal members with their extensions and attachment plates will be referred to in this disclosure as “bracket” or “side bracket”. Rising above and attached to seat section 4 are arm and back guard rails 11. These ensure that the user will not inadvertently laterally slide off seat section 4. Note that adjacent to the front portion of seat section 4 is a space 12 where the legs of a user will locate when he or she is sitting on the safety seat 4.

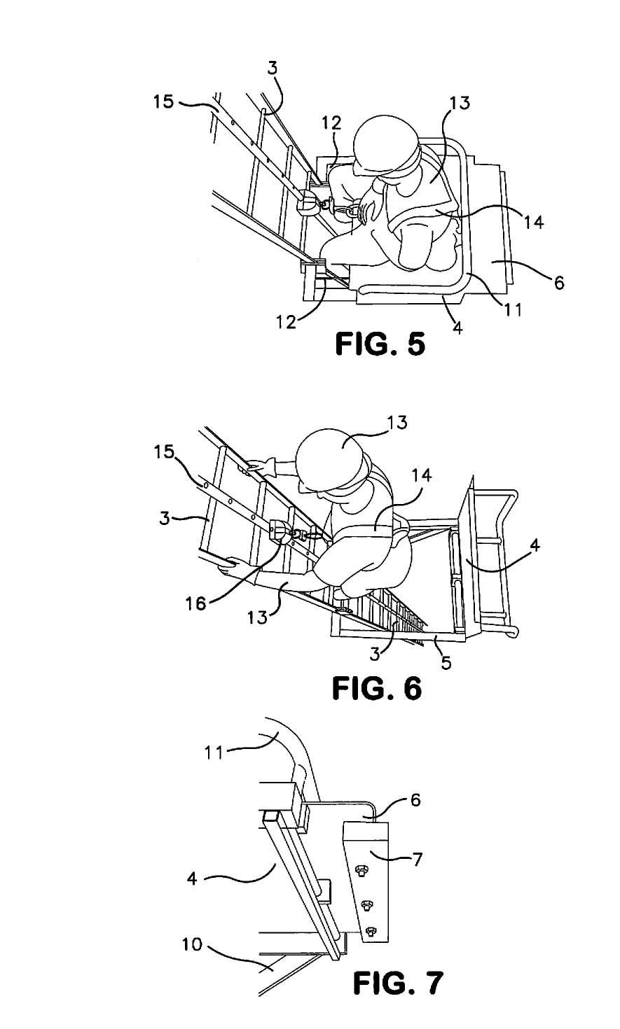

In FIG. 3, the seat section 4 and guard rails 11 are pivoted and moved upwardly automatically when user 13 lifts off the seat section 4. This occurs because counterweights or weights 7 will force seat 4 to pivot back out of seating position to an inactive position. The seat section 4 is easily lowered into seating active position as shown in FIG. 5. In FIG. 3, the overhang rear extension 6 is now in a vertical position relative to horizontal seat supports 5 and at an approximate 90° angle thereto. In one embodiment, the overhang extension 6 can be at an angle slightly greater than 90° relative to horizontal seat supports 5.

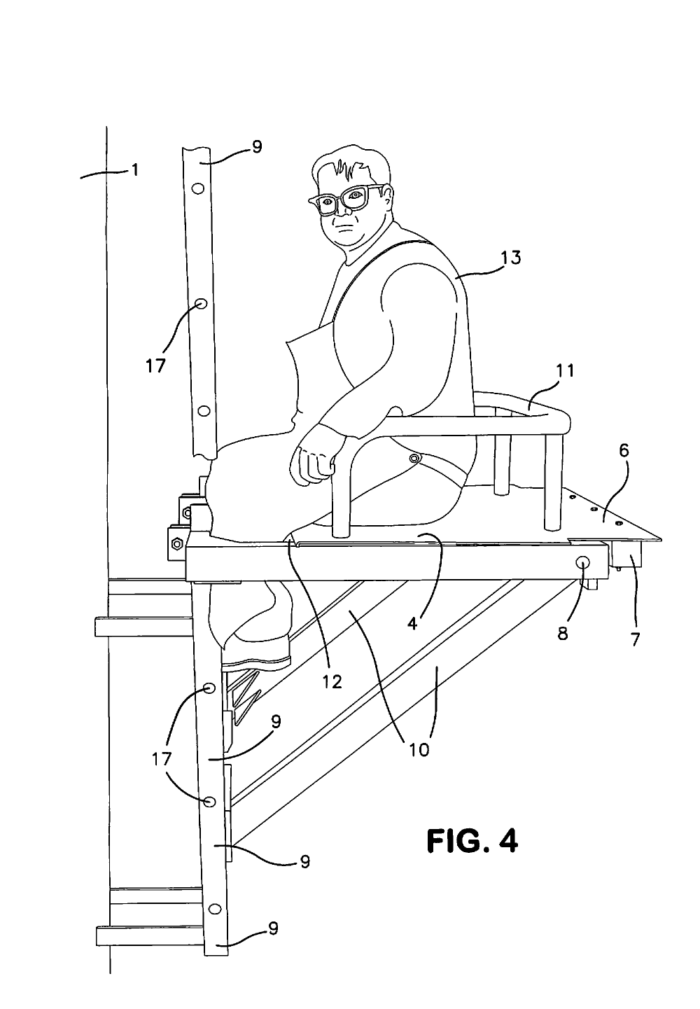

In FIG. 4, the user 13 is shown sitting or resting on seat section 4 having the security of guard rails 11 on which to relax. The user's legs are shown in leg space 12 as he is seated facing toward the ladder. Once he gets up from his seating position, the absence of the weight of the user 3 will automatically cause seat section 4 and guard rails 11 to rotate back to its vertical inactive position shown in FIG. 3. In this FIG. 4, for clarity, the continuation of side rails 9 is interrupted at the user.

In FIG. 5, a user 13 is resting on the seat section 4 of the safety seat 2. The seat section 4 is in the down-active position since downward pressure (the climber or worker's weight) is exerted on the seat section 4. The worker's 13 legs are located in leg space 12 while he is seated. Once he rises from the seat 4, the seat section automatically rotates upward in an inactive position as shown in FIG. 6, and the worker 13 continues to climb up the ladder 3. Note that the worker also wears a harness 14 which permits him normal movement and safety once he leaves the seat section 4 of this invention.

In FIG. 7, the seat section 4 is partially shown as it is in the down-active position. The counterweight 7 which is important to the present invention is shown in place. It is this counterweight 7 that causes the seat section 4 to spring or rotate upward in the inactive position once the worker lifts off the seat section 4. Fall prevention climb rail 15 and climb rail slide 16 is shown in FIGS. 6 and 7.

In summary, this invention provides a safety seat enabled to be permanently secured to a ladder. This safety seat comprises two horizontal seat supports with extensions perpendicular to ladder side rails permanently connected to the ladder. A seat section is configured to rest upon and be supported by these horizontal seat supports when the seat section is in a down usable active position. This seat section at a back portion is rotatable upward away from the horizontal seat supports to an inactive position. The seat section comprises at its back portion a counterweight. This counterweight is configured to cause the seat section to spring or rotate upwardly when any downward pressure upon the seat section is released.

The seat section in an active seating position when resting on the horizontal seat supports has a front and back portion. The front portion does not extend to a front terminal part of the horizontal seat supports and thereby forms a front space to accommodate leg space for a seated user. The back portion is configured to extend beyond and overhand the hinge and the horizontal seat supports. This overhang comprises these counterweights.

A side and back guard rail extend upwardly from the seat section and provide safety security to the side and back of a user. An overhang of the seat section extends beyond a rear terminal portion of a back guard and the seat section is pivotally mounted on a hinge. This hinge is located at a rear portion of and movably connects the seat section and the horizontal seat supports.

The safety seat brackets are securely attached to the ladder side rails. The seat section when in an active seating position has a leg space adjacent to its front section and an overhang at its back section.

A plurality of these safety seats is configured to be installed at vertical intervals of the ladder to provide thereby multiple resting levels for a ladder climber. These safety seats are configured to rotate upwardly in an inactive position after the climber leaves the safety seat to continue climbing upwardly. The safety seat is configured to stay in the inactive position until a climber again moves it into an active downward seating position.

It will be appreciated that variations of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A safety seat assembly enabled to be permanently secured to a ladder, said safety seat assembly comprising:
two horizontal seat supports with extensions perpendicular to ladder side rails permanently connected to said ladder,
a seat section configured to rest upon and supported by said horizontal seat supports when said seat section is in a down, usable position,
said seat section at a back portion rotates upward away from said horizontal seat supports,
said seat section comprising at said back portion a counterweight, said counterweight configured to cause said seat section to automatically rotate upwardly and out of the way when any downward pressure upon said seat section is released.

2. The safety seat assembly of claim 1 wherein said seat section is in an active seating position when resting on said horizontal seat supports and has a front and said back portion, said front portion not extending to a front terminal part of said horizontal seat supports and thereby forming a front space to accommodate leg space for a seated user.

3. The safety seat assembly of claim 1 wherein said seat section in an active position when resting on said horizontal seat supports has a front and said back portion, said back portion configured to extend beyond and overhang a back portion of said horizontal seat supports, said overhang comprising said counterweight.

4. The safety seat assembly of claim 1 wherein a side and back guard rail extends upwardly from said seat section and provides safety security for side or back sliding of a user.

5. The safety seat assembly of claim 1 wherein an overhang of said seat section extends beyond a rear terminal portion of a back guard rail.

6. The safety seat assembly of claim 1 wherein said seat section rotates on a pivoting hinge located between the two supports and at a rear portion of said horizontal seat supports.

7. The safety seat assembly of claim 1 wherein said seat is securely attached to said ladder side rails by side brackets.

8. The safety seat assembly of claim 1 wherein said seat section when in an active seating position has a leg space adjacent its front section and an overhang at its back section.

9. A safety seat enabled to be permanently secured to a ladder, said safety seat comprising:
two horizontal seat supports with extensions perpendicular to ladder side rails permanently connected to said ladder,
a seat section configured to rest upon and supported by said horizontal seat supports when said seat section is in a down usable or active position,
said seat section at a back portion rotates upward away from said horizontal seat supports to an inactive position,
said seat section comprising at said back portion a counterweight, said counterweight configured to cause said seat section to automatically rotate upwardly and out of the way to an inactive position when any downward pressure upon said seat section is released,
a plurality of said safety seats configured to be installed at vertical intervals of said ladder to provide thereby several resting levels for a ladder climber, and
said safety seats configured to automatically rotate upwardly to said inactive position after said climber leaves said safety seat to continue climbing, said safety seat configured to stay in said inactive position until a climber again moves it into an active seating position.

10. The safety seat of claim 9 wherein said seat section in an active seating position when resting on said horizontal seat supports has a front and said back portion, said front portion not extending to a front terminal part of said horizontal seat supports and thereby forming a front space to accommodate leg space for a seated user.

11. The safety seat of claim 9 wherein said seat section in an active position when resting on said horizontal seat supports has a front and said back portion, said back portion configured to extend beyond and overhang a back portion of said horizontal seat supports, said overhang comprising said counterweight.

12. The safety seat of claim 9 wherein a guard rail on the sides and back extends upwardly from said seat section and provides safety security for side or back sliding of a user.

13. The safety seat of claim 9 wherein an overhang of said seat section extends beyond a rear terminal portion of a back guard rail.

14. The safety seat of claim 9 wherein said seat section rotates on a pivoting hinge located between the two supports and at a rear portion of said horizontal seat supports.

15. The safety seat of claim 9 wherein said seat is securely attached to said ladder side rails by side brackets.

16. The safety seat of claim 9 wherein said seat section when in an active seating position has a leg space adjacent to its front section and a counterweighted overhang at its back section.
